(19) United States
(12) Patent Application Publication
(10) Pub. No.: US 2019/0086680 A1
(43) Pub. Date: Mar. 21, 2019

(54) DISPLAY DEVICE, AND OPERATING METHOD THEREOF

(71) Applicant: Boe Technology Group Co, Ltd, Beijing (CN)

(72) Inventors: Xiaochen NIU, Beijing (CN); Chen-Yu CHEN, Beijing (CN); Xue DONG, Beijing (CN); Xiaochuan CHEN, Beijing (CN); Wenqing ZHAO, Beijing (CN)

(21) Appl. No.: 16/008,657

(22) Filed: Jun. 14, 2018

(30) Foreign Application Priority Data
Sep. 15, 2017 (CN) 201710840387.5

(51) Int. Cl. G02B 27/22; G02F 1/29

(52) U.S. Cl. CPC G02B 27/2214; H04N 13/359; G02F 1/29

(57) ABSTRACT

The disclosure discloses a display device, and an operating method thereof. The display device includes an array of liquid crystal lenses, the array includes liquid crystal micro-lenses, each of which includes a first electrode layer and a second electrode layer, both of which have circular contour and are arranged in a direction of an axis thereof, and a liquid crystal layer located between the two electrode layers When the display device operates in a 2D display mode, the liquid crystal layer operates as planar glass under an action of an electric field generated between the first electrode layer and the second electrode layer; and when the display device operates in a 3D display mode, the liquid crystal layer operates as a convex lens under the action of the electric field generated between the first electrode layer and the second electrode layer.

### CROSS-REFERENCE TO RELATED APPLICATION

This Application claims priority to Chinese Patent Application No. 201710840387.5, filed on Sep. 15, 2017, the content of which is incorporated by reference in the entirety.

### TECHNICAL FIELD

This disclosure relates to the field of display technologies, and particularly to a display device, and an operating method thereof.

### DESCRIPTION OF THE RELATED ART

As the three-dimensional (3D) display technologies are advancing, there is a growing demand of a 3D display device; and the 3D display technologies can be categorized into visually aided and visually unaided 3D display technologies dependent upon whether a visually aided device is worn, where the visually unaided 3D display technologies are particularly favored by their consumers due to their advantage of being free of a visually aided device.

The visually unaided 3D display technologies can be categorized into grating, integrated imaging, holographic, and body 3D display technologies, where the grating 3D display technology is the most mature 3D display technology at present, and has been applied to a mobile phone, a computer, a TV set, and other display products. However since a 3D display effect is achieved using a binocular parallax in the grating 3D display technology, a watching user may easily feel visually fatigued.

### SUMMARY

Embodiments of the disclosure disclose a display device, and an operating method thereof.

In an aspect, embodiments of the disclosure provide a display device including a display panel, and an array of liquid crystal lenses located on a light emitting side of the display panel, wherein the array of liquid crystal lenses includes liquid crystal micro-lenses; each liquid crystal micro-lens includes a first electrode layer and a second electrode layer, both of which are arranged in a direction of an axis of the liquid crystal micro-lens, and a liquid crystal layer located between the first electrode layer and the second electrode layer, and both the first electrode layer and the second electrode layer have circular contours; and when the display device operates in a 2D display mode, the liquid crystal layer operates as planar glass under an action of an electric field generated between the first electrode layer and the second electrode layer; or when the display device operates in a 3D display mode, the liquid crystal layer operates as a convex lens under the action of the electric field generated between the first electrode layer and the second electrode layer.

In some embodiments, the first electrode layer includes an annular electrode arranged along an edge thereof, and a central electrode located inside the annular electrode.

In some embodiments, the annular electrode shapes as a circular ring, and a center of the annular electrode is located on the axis of the liquid crystal micro-lens; and the central electrode shapes as a circle, and a center of the central electrode coincides with the center of the annular electrode.

In some embodiments, the second electrode layer includes only a circular electrode; and a center of the circular electrode is located on the axis of the liquid crystal micro-lens.

In some embodiments, liquid crystal molecules in the liquid crystal layer are positive liquid crystal molecules.

In some embodiments, when the display device operates in the 2D display mode, voltage of the annular electrode is different from voltage of the second electrode layer, and voltage of the central electrode is same as the voltage of the annular electrode; or when the display device operates in the 3D display mode, the voltage of the annular electrode is different from the voltage of the second electrode layer, and the voltage of the central electrode is the same as the voltage of the second electrode layer.

In some embodiments, the first electrode layer and the second electrode layer are transparent electrode layers.

In some embodiments, a material of the transparent electrode layers is Indium Tin Oxide (ITO).

In some embodiments, the liquid crystal micro-lens further includes two alignment films located on two sides of the liquid crystal layer, and an alignment direction of the alignment films is parallel to the liquid crystal layer, and radiates outward from a center line which is the axis of the liquid crystal micro-lens.

In some embodiments, the display panel is a liquid crystal display panel or an organic light emitting display panel.

In another aspect, the embodiments of the disclosure further provide an operating method of the display device above according to the embodiments of the disclosure, the method including: applying different voltage to the annular electrode and the second electrode layer, and applying same voltage to the central electrode and the annular electrode so that the display device operates in the 2D display mode; or applying different voltage to the annular electrode and the second electrode layer, and applying same voltage to the central electrode and the second electrode layer so that the display device operates in the 3D display mode.

### BRIEF DESCRIPTION OF THE DRAWINGS

In order to make the technical solutions according to embodiments of the disclosure more apparent, the drawings to which a description of the embodiments refers will be briefly introduced below, and apparently the drawings to be described below are merely illustrative of some of the embodiments of the disclosure, and those ordinarily skilled in the art can derive from these drawings other drawings without any inventive effort.

FIG. 1 is a schematic structural diagram of a display device according to the embodiments of the disclosure;

FIG. 2 is a schematic structural diagram of a liquid crystal lens in a display device according to the embodiments of the disclosure in a sectional view;

FIG. 3 is a schematic structural diagram of a liquid crystal lens in a display device according to the embodiments of the disclosure in an operating state in a sectional view;

FIG. 4 is a schematic structural diagram of a liquid crystal lens in a display device according to the embodiments of the disclosure in another operating state in a sectional view;

FIG. 5 is a schematic structural diagram of a first electrode layer of a liquid crystal lens in a display device according to the embodiments of the disclosure;

FIG. 6 is a schematic structural diagram of a liquid crystal layer of a liquid crystal lens in a display device according to the embodiments of the disclosure in an initial alignment state; and

FIG. 7 is a flow chart of an operating method of a display device according to the embodiments of the disclosure.

### DETAILED DESCRIPTION OF THE EMBODIMENTS

The technical solutions according to the embodiments of the disclosure will be described below clearly and fully with reference to the drawings in the embodiments of the disclosure, and apparently the embodiments to be described are only a part but not all of the embodiments of the disclosure. Based upon the embodiments here of the disclosure, all the other embodiments which can occur to those ordinarily skilled in the art without any inventive effort shall fall into the scope of the disclosure.

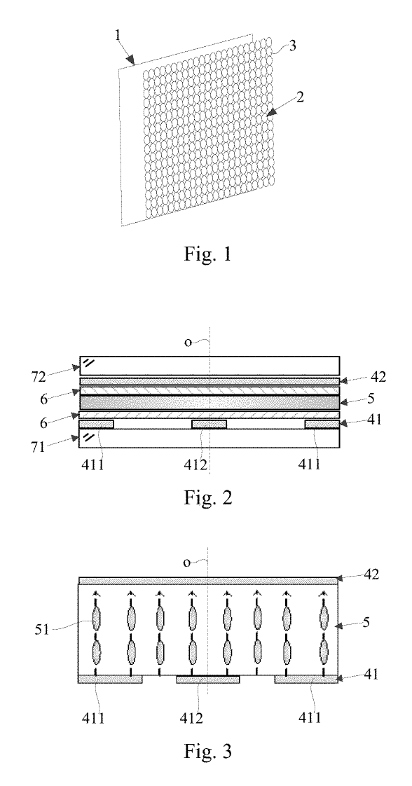

As illustrated in FIG. 1 to FIG. 5, a display device according to the embodiments of the disclosure includes a display panel 1, and an array of liquid crystal lenses 2 located on a light emitting side of the display panel 1, where the array of liquid crystal lenses 2 includes liquid crystal micro-lenses 3; each liquid crystal micro-lens 3 includes a first electrode layer 41 and a second electrode layer 42, both of which are arranged in a direction of an axis o of the liquid crystal micro-lens 3, and each liquid crystal micro-lens 3 further includes a liquid crystal layer 5 located between the first electrode layer 41 and the second electrode layer 42, both the first electrode layer 41 and the second electrode layer 42 have circular contours; when the display device operates in a 2D display mode, the liquid crystal layer 5 operates as planar glass under the action of an electric field generated between the first electrode layer 41 and the second electrode layer 42; and when the display device operates in a 3D display mode, the liquid crystal layer 5 operates as a convex lens under the action of the electric field generated between the first electrode layer 41 and the second electrode layer 42.

In the display device according to the embodiments of the disclosure, the array of liquid crystal lenses 2 includes the liquid crystal micro-lenses 3; and in each liquid crystal micro-lens 3, liquid crystal molecules 51 in the liquid crystal layer 5 can be arranged in different patterns under the control of the electric field generated between the first electrode layer 41 and the second electrode layer 42, so that the liquid crystal layer 5 optically operates as planar glass or a convex lens, so the form of the electric field between the first electrode layer 41 and the second electrode layer 42 can be varied to thereby control the liquid crystal micro-lenses 3 to be switched to present different optical effects. For example, while the display device operates in the 2D display mode, each liquid crystal micro-lens 3 in the array of liquid crystal lenses 2 can be switched to operate as planar glass; and while the display device operates in the 3D display mode, each liquid crystal micro-lens 3 in the array of liquid crystal lenses 2 can be switched to operate as a convex lens. That is, while the display device operates in the 2D display mode, each liquid crystal micro-lens 3 is equivalent to a planar lens, so the array of liquid crystal lenses 2 including the liquid crystal micro-lenses 3 will not affect an effect of displaying an image on the display panel, thus the display effect of the display device is still an effect of displaying a 2D image on the display panel 1; and while the display device operates in the 3D display mode, each liquid crystal micro-lens 3 is equivalent to a convex lens, so the entire array of liquid crystal lenses 2 is equivalent to an array of circular convex lenses, and a 2D image displayed on the display panel 1 can be transformed by the array of circular convex lenses 2 into a plurality of integrated facets, thus the display effect of the display device is an effect of integrated 3D imaging.

In summary, the display device above according to the embodiments of the disclosure can be switched between the 2D and 3D display modes to operate in one of them, and operate with integrated 3D imaging in the 3D display mode without visually fatiguing a viewer.

In some embodiments, as illustrated in FIG. 2 to FIG. 5, in the display device according to the embodiments of the disclosure, in each liquid crystal micro-lens 3, the first electrode layer 41 includes two electrode components, where one electrode component is an annular electrode 411 arranged along an edge of the first electrode layer 41, and the other electrode component is a central electrode 412 located inside the annular electrode 411.

In some embodiments, as illustrated in FIG. 5, in the first electrode layer 41, the annular electrode 411 shapes as a circular ring, and a center thereof is located on the axis o of the liquid crystal micro-lens 3; and the central electrode 412 shapes as a circle, and a center thereof coincides with the center of the annular electrode 411.

In some embodiments, the second electrode layer 42 of the liquid crystal micro-lens 3 above according to the embodiments of the disclosure is an electrode structure consecutive throughout the layer, that is, the second electrode layer 42 includes only a circular electrode.

For the liquid crystal micro-lens 3 above according to the embodiments of the disclosure, voltage of the annular electrode 411, the central electrode 412, and the second electrode layer 42 thereof can be set respectively to create an electric field in a specific form as needed, so that the liquid crystal molecules 51 in different areas of the liquid crystal layer 5 can be inclined at desirable angles and arranged with desirable effects respectively, that is, the liquid crystal micro-lens 3 can optically operate as a planar lens or a circular convex lens.

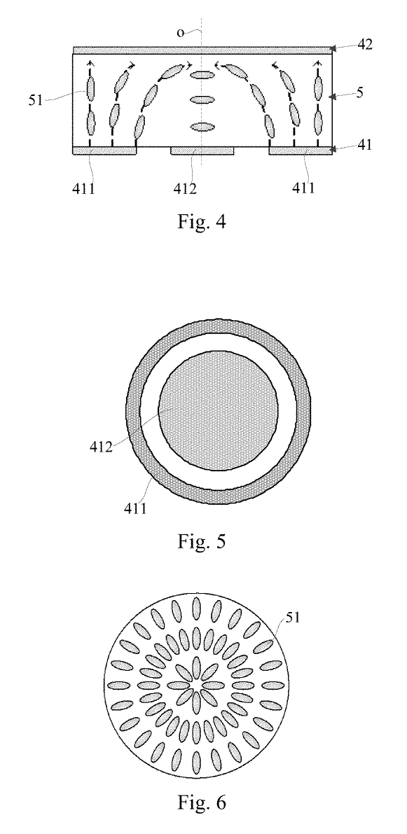

In some embodiments, as illustrated in FIG. 3 and FIG. 4, in the display device according to the embodiments of the disclosure, the liquid crystal molecules 51 in each liquid crystal micro-lens 3 are positive liquid crystal molecules, that is, major axes of the liquid crystal molecules 51 thereof are arranged in a direction parallel to an electric field line.

In some embodiments, as illustrated in FIG. 2 and FIG. 3, while the display device operates in the 2D display mode, in the liquid crystal micro-lens 3 above according to the embodiments of the disclosure, voltage of the annular electrode 411 is set different from voltage of the second electrode layer 42, and voltage of the central electrode 412 is set same as the voltage of the annular electrode 411. At this time, a direction of an electric field line in the liquid crystal micro-lens 3 is perpendicular to the electrode layer as denoted by the dotted line with an arrow in FIG. 3, and the liquid crystal molecules 51 in the liquid crystal micro-lens 3 are arranged perpendicular to the electrode layer under the action of the electric field; and furthermore the liquid crystal micro-lens 3 optically operates similarly to a planar lens, so the display device can operate in the 2D display mode.

In some embodiments, as illustrated in FIG. 2 and FIG. 4, while the display device operates in the 3D display mode, in the liquid crystal micro-lens 3 above according to the embodiments of the disclosure, the voltage of the annular electrode 411 is set different from the voltage of the second electrode layer 42, and the voltage of the central electrode 412 is set same as the voltage of the second electrode layer 42. At this time, as denoted by the dotted line with an arrow in FIG. 4, in the liquid crystal micro-lens 3, a direction of an electric field line in a central area is parallel to the electrode layer, a direction of an electric field line in an annular edge area is perpendicular to the electrode layer, and directions of electric field lines in the other areas are transitioning between the two directions. And in the liquid crystal micro-lens 3, the liquid crystal molecules 51 in the central area are arranged parallel to the electrode layer, the liquid crystal molecules 51 in the annular edge area are arranged perpendicular to the electrode layer, and all the liquid crystal molecules 51 between the central area and the annular edge area are arranged inclined toward the central area, under the action of the electric field. At this time, the liquid crystal micro-lens 3 optically operates similarly to a convex lens, so the display device can operate in the 3D display mode.

In some embodiments, as illustrated in FIG. 2, in the display device according to the embodiments of the disclosure, each liquid crystal micro-lens 3 in the array of liquid crystal lenses 2 further includes two alignment films 6 located respectively between the liquid crystal layer 5 and the first electrode layer 41, and between the liquid crystal layer 5 and the second electrode layer 42, and an alignment direction of the alignment films 6 is parallel to the the liquid crystal layer, and radiates outward from a center line thereof which is the axis o of the liquid crystal micro-lens 3. Since the liquid crystal molecules 51 are arranged in the alignment direction of the alignment films 6 while they are not driven by the electric field, the liquid crystal molecules 51 are arranged extending radially from the center of the liquid crystal micro-lens 3 toward the edge thereof as illustrated in FIG. 6 while there is no voltage applied to the first electrode layer 41 and the second electrode 42, so while the display panel 1 operates in the 3D display mode, all the liquid crystal molecules 51 can be arranged inclined toward the center rapidly under the action of the voltage, so the display device can be switched rapidly to the 3D display mode.

In some embodiments, as illustrated in FIG. 2, both the first electrode layer 41 and the second electrode layer 42 are transparent electrode layers, e.g., Indium Tin Oxide (ITO) electrodes.

In some embodiments, as illustrated in FIG. 2, each liquid crystal micro-lens 3 further includes a first transparent substrate 71 located on a side of the first electrode layer 41 facing away from the liquid crystal layer 5, and a second transparent substrate 72 located on a side of the second electrode layer 42 facing away from the liquid crystal layer 5.

In some embodiments, in the display device according to the embodiments of the disclosure, the display panel 1 is a liquid crystal display panel 1, or an organic light emitting display panel 1.

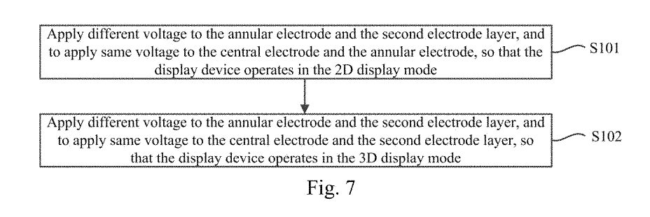

Further to the display device above according to the embodiments of the disclosure, the embodiments of the disclosure further provides an operating method of a display device, and as illustrated in FIG. 7, the method includes the following operations.

The operation S101 is to apply different voltage to the annular electrode and the second electrode layer, and to apply same voltage to the central electrode and the annular electrode, so that the display device operates in the 2D display mode.

The operation S102 is to apply different voltage to the annular electrode and the second electrode layer, and to apply same voltage to the central electrode and the second electrode layer, so that the display device operates in the 3D display mode.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A display device, comprising a display panel, and an array of liquid crystal lenses located on a light emitting side of the display panel, wherein:
the array of liquid crystal lenses comprises liquid crystal micro-lenses; each liquid crystal micro-lens comprises a first electrode layer and a second electrode layer, both of which are arranged in a direction of an axis of the liquid crystal micro-lens, and a liquid crystal layer located between the first electrode layer and the second electrode layer, and both the first electrode layer and the second electrode layer have circular contours; and
when the display device operates in a 2D display mode, the liquid crystal layer operates as planar glass under an action of an electric field generated between the first electrode layer and the second electrode layer; or when the display device operates in a 3D display mode, the liquid crystal layer operates as a convex lens under the action of the electric field generated between the first electrode layer and the second electrode layer.

2. The display device according to claim 1, wherein the first electrode layer comprises an annular electrode arranged along an edge thereof, and a central electrode located inside the annular electrode.

3. The display device according to claim 2, wherein:
the annular electrode shapes as a circular ring, and a center of the annular electrode is located on the axis of the liquid crystal micro-lens; and
the central electrode shapes as a circle, and a center of the central electrode coincides with the center of the annular electrode.

4. The display device according to claim 2, wherein the second electrode layer comprises only a circular electrode; and a center of the circular electrode is located on the axis of the liquid crystal micro-lens.

5. The display device according to claim 2, wherein liquid crystal molecules in the liquid crystal layer are positive liquid crystal molecules.

6. The display device according to claim 2, wherein:
when the display device operates in the 2D display mode, voltage of the annular electrode is different from voltage of the second electrode layer, and voltage of the central electrode is same as the voltage of the annular electrode; or
when the display device operates in the 3D display mode, the voltage of the annular electrode is different from the voltage of the second electrode layer, and the voltage of the central electrode is the same as the voltage of the second electrode layer.

7. The display device according to claim 1, wherein the first electrode layer and the second electrode layer are transparent electrode layers.

8. The display device according to claim 7, wherein a material of the transparent electrode layers is Indium Tin Oxide (ITO).

9. The display device according to claim 1, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

10. The display device according to claim 2, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

11. The display device according to claim 3, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

12. The display device according to claim 4, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

13. The display device according to claim 5, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

14. The display device according to claim 6, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

15. The display device according to claim 7, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

16. The display device according to claim 8, wherein the liquid crystal micro-lens further comprises two alignment films located on two sides of the liquid crystal layer, and an alignment direction of the alignment films is parallel to the liquid crystal layer, and radiates outward from a center line which is the axis of the liquid crystal micro-lens.

17. The display device according claim 1, wherein the display panel is a liquid crystal display panel or an organic light emitting display panel.

18. An operating method of the display device according to claim 2, the method comprising:
applying different voltage to the annular electrode and the second electrode layer, and applying same voltage to the central electrode and the annular electrode so that the display device operates in the 2D display mode; or
applying different voltage to the annular electrode and the second electrode layer, and applying same voltage to the central electrode and the second electrode layer so that the display device operates in the 3D display mode.
